(19) United States
(12) Patent Application Publication
(10) Pub. No.: US 2005/0006024 A1
(43) Pub. Date: Jan. 13, 2005

(54) Method and device for feeding a continuous strip of packing material and a tear-off ribbon to a user machine

(75) Inventor: Mario Spatafora, Bologna (IT)

Correspondence Address: Ladas & Parry, 26 West 61 Street, New York, NY, 10023, US

(73) Assignee: G.D SOCIETA' PER AZIONI

(21) Appl. No.: 10/811,235

(22) Filed: Mar. 26, 2004

(30) Foreign Application Priority Data
Mar. 31, 2003 (IT) BO2003A000179

(51) Int. Cl. B32B 31/08

(52) U.S. Cl. 156/164; 156/301

(57) ABSTRACT

A method and device for feeding a continuous strip of packing material and a tear-off ribbon to a user machine, and whereby the continuous strip and the tear-off ribbon are unwound simultaneously off respective reels and fed along respective paths and at the same speed through a joining station, where the continuous strip and the tear-off ribbon are joined to each other to form a composite strip of packing material, which is fed to the user machine via a traction assembly which exerts a first pulling force on the continuous strip and the tear-off ribbon; a further traction assembly engaging a portion of the tear-off ribbon extending between the relative reel and the joining station, to exert on the portion a second pulling force in the same direction as the first.

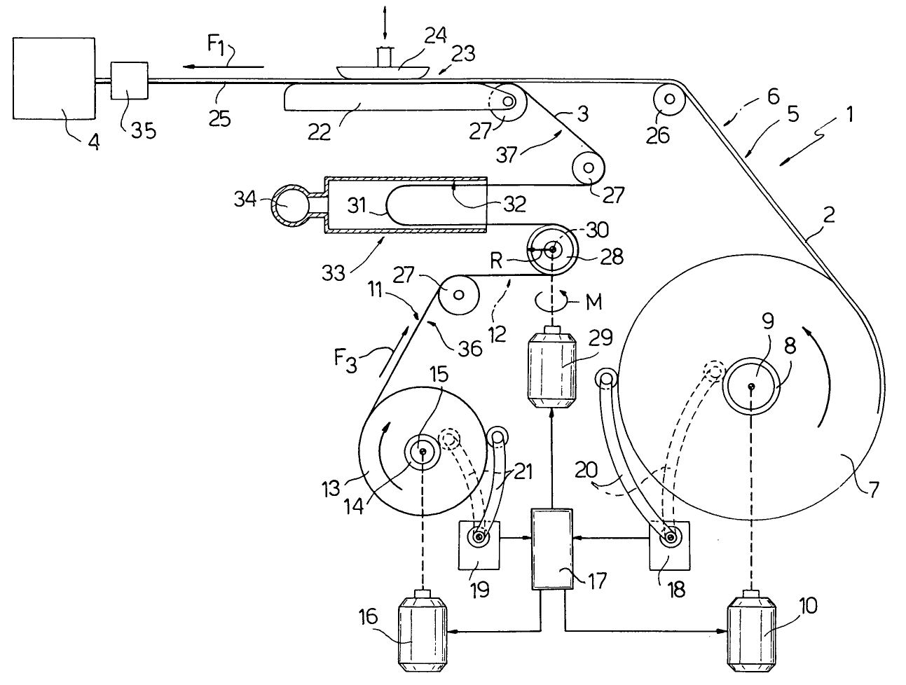

The present invention relates to a method and device for feeding a continuous strip of packing material and a tear-off ribbon to a user machine.

The present invention is particularly advantageous for use on cellophaning or overwrapping machines, to which the following description refers purely by way of example.

### BACKGROUND OF THE INVENTION

Cellophaning machines are known to employ packing material feed devices in which a continuous strip of packing material and a tear-off ribbon are unwound off respective reels and fed at the same speed along respective paths extending through a joining station where the continuous strip and the tear-off ribbon are joined to form a composite strip, which is fed by a traction assembly to an input of a cellophaning machine.

The two reels of known feed devices of the above type are driven by respective motors and so controlled that their peripheral speeds are the same at all times, and the pull required to unwind the continuous strip and relative tear-off ribbon is supplied by the traction assembly.

In connection with the above, it should be pointed out that, whereas relatively little pull is required to unwind the continuous strip, the tear-off ribbon, being a cold-apply adhesive ribbon, calls for much greater pull to unwind; and the traction assembly must necessarily subject the composite strip to the greater pull required to unwind the tear-off ribbon.

This may result in several drawbacks, on account of the widely differing widths of the strip and ribbon joined to form the composite strip, so that, when the pull required to unwind the tear-off ribbon is applied, the tear-off ribbon undergoes, upstream from the joining station, a much higher percentage of stretch than the continuous strip. Since no pull is applied on the composite strip downstream from the traction assembly, thus enabling elastic recovery of both the continuous strip and the tear-off ribbon, the greater recovery of the tear-off ribbon may produce wrinkling of the continuous strip if this, as is normally the case, is not stiff enough to withstand the compression exerted on it by the tear-off ribbon, thus preventing elastic recovery of the ribbon.

### SUMMARY OF THE INVENTION

It is an object of the present invention to provide a method of feeding a continuous strip of packing material and a tear-off ribbon to a user machine, designed to eliminate the aforementioned drawback.

According to the present invention, there is provided a method of feeding a continuous strip of packing material and a tear-off ribbon to a user machine, as claimed in claim 1 and, preferably, in any one of the following claims depending directly or indirectly on claim 1.

According to the present invention, there is also provided a device for feeding a continuous strip of packing material and a tear-off ribbon to a user machine, as claimed in claim 6 and, preferably, in any one of the following claims depending directly or indirectly on claim 6.

### BRIEF DESCRIPTION OF THE DRAWING

The present invention will be described with reference to the accompanying drawing showing a schematic non-limiting embodiment.

### DETAILED DESCRIPTION OF THE INVENTION

Number 1 in the accompanying drawing indicates as a whole a device for feeding a continuous strip 2 of packing material, normally transparent packing material, and a tear-off ribbon 3 to a cellophaning machine 4.

Device 1 comprises a first line 5 for feeding strip 2 along a path 6 off a reel 7, a core 8 of which is fitted to a shaft 9 supporting reel 7 and rotated about its own axis by a motor 10; and a second line 11 for feeding tear-off ribbon 3 along a path 12 off a reel 13, a core 14 of which is fitted to a shaft 15 supporting reel 13 and rotated about its own axis by a motor 16.

A logic unit 17 feedback-controls motors 10 and 16 to impart the same external linear speed to reels 7 and 13, the outside diameters of which are measured instant by instant by respective known transducers 18 and 19 connected to logic unit 17 and having respective feelers 20 and 21 contacting the outer periphery of reels 7 and 13 respectively.

The two paths 6 and 12 converge over a conveying plate 22 at a joining station 23 where a pad 24, moved to and from an operating position contacting conveying plate 22 by a known actuator not shown, joins strip 2 and tear-off ribbon 3 integrally to form a composite strip 25 of packing material complete with a tear-off ribbon.

Upstream from joining station 23, path 6 is defined by a guide device comprising a guide pulley 26; and path 12 is defined by a guide device comprising a number of guide pulleys 27, and by a traction assembly comprising a drive pulley 28, of radius R, powered by a motor 29 to rotate, about a respective axis 30 parallel to shaft 15, in the same direction as the travelling direction of tear-off ribbon 3 to joining station 23. Motor 29 is a variable-speed motor with a constant torque M, and is speed-controlled by logic unit 17 so that the tangential speed of the periphery of drive pulley 28 contacting tear-off ribbon 3 is maintained constantly equal, in value and sign, to the tangential speed of reel 13 to prevent any slippage of tear-off ribbon 3 with respect to the periphery of drive pulley 28.

Immediately downstream from drive pulley 28, tear-off ribbon 3 forms a bend 31 inside a chamber 32 of a pneumatic compensating assembly 33 for generating, by suction along a suction header 34, a vacuum by which to vary the length of path 12.

Downstream from joining station 23, composite strip 25, before reaching cellophaning machine 4, is fed through a known traction assembly 35 for exerting on composite strip 25, and therefore on tear-off ribbon 3 and strip 2, a relatively weak pulling force F1 sufficient to unwind strip 2 off reel 7, but producing no noticeable stretch of tear-off ribbon 3 with respect to strip 2. Tear -off ribbon 3, however, being a cold-apply adhesive ribbon, requires much greater pulling force to unwind, so that force F1 alone is too low to unwind tear-off ribbon 3 off reel 13. The additional force, of value F2=M/R and concordant with force F1, is imparted by motor 29 to the portion 36 of tear-off ribbon 3 extending between drive pulley 28 and reel 13, so that, whereas the portion 37 of tear-off ribbon 3 downstream from drive pulley 28 is subjected to pulling force F1, portion 36 of tear-off ribbon 3 is subjected to a pulling force F3 of:
F3=F1+F2=F1+M/R
which may be of any value depending on the torque delivered by motor 16, while still maintaining force F1 as low as required, but sufficient to unwind strip 2.

In other words, simply using the additional traction assembly defined by motor 29 and by drive pulley 28 rotated at a peripheral speed equal at all times to the peripheral speed of reel 13, the correct unwinding pull can be exerted on tear-off ribbon 3, while at the same time exerting sufficiently weak pull on the portion 37 of tear-off ribbon 3 joined to strip 2 to substantially prevent any wrinkling of composite strip 25 when pulling force F1 is removed downstream from traction assembly 35.

1) A method of feeding a continuous strip (2) of packing material and a tear-off ribbon (3) to a user machine (4), the method comprising the steps of unwinding said continuous strip (2) and said tear-off ribbon (3) simultaneously off respective reels (7, 13); feeding the continuous strip (2) and the tear-off ribbon (3) at the same speed along respective paths (6, 12) extending through a joining station (23); joining the continuous strip (2) and the tear-off ribbon (3) to each other at said joining station (23) to form a composite strip (25) of packing material; and feeding the composite strip (25) to said user machine (4) via first traction means (35) which exert a first pulling force (F1) on the continuous strip (2) and tear-off ribbon (3) via the composite strip (25); and being characterized by comprising the further step of exerting, simultaneously with and in addition to said first pulling force (F1) and by means of second traction means (28, 29), a second pulling force (F2) on a portion (36) of said tear-off ribbon (3) extending between the relative said reel (13) and said joining station (23).

2) A method as claimed in claim 1, wherein said second pulling force (F2) is exerted by winding said portion (36) of tear-off ribbon (3) about a pulley (28), and applying to the pulley (28) a given drive torque (M) in the same direction as a travelling direction of said portion (36) of tear-off ribbon (3) to the joining station (23).

3) A method as claimed in claim 2, wherein said pulley (28) is speed-controlled to impart to the pulley (28) a peripheral speed equal to the travelling speed of the tear-off ribbon (3).

4) A method as claimed in claim 1, wherein the sum of said first and said second pulling force (F1, F2) is a pulling force (F3) at least sufficient to unwind said tear-off ribbon (3) off the relative said reel (13).

5) A method as claimed in claim 1, wherein said first pulling force (F1) is at least sufficient to unwind the continuous strip (2) off the relative said reel (7).

6) A device for feeding a continuous strip (2) of packing material and a tear-off ribbon (3) to a user machine (4), the device (1) comprising first and second supporting means (9, 15) for respectively supporting a first and a second reel (7, 13) powered to rotate, in use, at the same peripheral speed, said first and said second reel (7, 13) being a reel (7) of said continuous strip (2) and a reel (13) of said tear-off ribbon (3); first and second guide means (26, 27) for respectively guiding the continuous strip (2) and the tear-off ribbon (3) along respective paths (6, 12); a joining station (23) through which both said paths (6, 12) extend; joining means (22, 24) located at said joining station (23) to join the continuous strip (2) and the tear-off ribbon (3) to each other to form a composite strip (25) of packing material; and first traction means (35) which cooperate with said composite strip (25) to transmit a first pulling force (F1) to the continuous strip (2) and the tear-off ribbon (3); and being characterized by comprising second traction means (28, 29) for exerting, simultaneously with and in addition to said first pulling force (F1), a second pulling force (F2) on a portion (36) of the tear-off ribbon (3) extending between the relative said reel (13) and the joining station (23).

7) A device as claimed in claim 6, wherein said second traction means (28, 29) comprise a pulley (28) which cooperates with said portion (36) of tear-off ribbon (3); and drive means (29) for applying to said pulley (28) a given torque (M) in the same direction as a travelling direction of said portion (36) of tear-off ribbon (3) to said joining station (23).

8) A device as claimed in claim 7, wherein control means (17) are provided to regulate said drive means (29) so as to impart to said pulley (28) a peripheral speed equal to said peripheral speed of said reels (7, 13) and, therefore, to a travelling speed of the tear-off ribbon (3).

9) A device as claimed in claim 6, wherein the sum of said first and said second pulling force (F1, F2) is a pulling force (F3) at least sufficient to unwind said tear-off ribbon (3) off the relative said reel (13).

10) A device as claimed in claim 6, wherein said first pulling force (F1) is at least sufficient to unwind said continuous strip (2) off the relative said reel (7).
